(19) United States
(12) Patent Application Publication
(10) Pub. No.: US 2017/0262162 A1
(43) Pub. Date: Sep. 14, 2017

(54) METHOD AND ELECTRONIC DEVICE FOR PROCESSING TERMINAL FOLDER

(71) Applicants: LE HOLDINGS (BEIJING) CO., LTD., Beijin (CN); LEMOBILE INFORMATION TECHNOLOGY (BEIJING) CO., LTD., Beijing (CN)

(72) Inventor: ZHIPAN ZHANG, BEIJING (CN)

(21) Appl. No.: 15/120,875

(22) PCT Filed: Jul. 5, 2016
(86) PCT No.: PCT/CN2016/088594

§ 371 Date: Aug. 23, 2016

(30) Foreign Application Priority Data
Nov. 20, 2015 (CN) 201510810948.8

(51) Int. Cl. G06F 3/0484; G06F 3/0488; G06F 17/30; G06F 3/0481

(52) U.S. Cl. CPC G06F 3/04845; G06F 3/04817; G06F 3/0488; G06F 17/30126; G06F 2203/04806

(57) ABSTRACT

A method and an electronic device for processing terminal folder are provided, wherein the method includes: detecting folder operation instructions triggered with respect to a folder to be processed; dynamically scaling-displaying a folder icon of the folder to be processed according to the folder operation instructions; and dynamically adjusting a display of a sub-file icon, in the folder icon, in the folder to be processed according to a scale of the folder icon.

### CROSS-REFERENCES TO RELATED APPLICATIONS

The present disclosure is continuation of International Application No. PCT/CN2016/088594, filed on Jul. 5, 2016 which is based upon and claims priority to Chinese Patent Application No. 201510810948.8, filed on Nov. 20, 2015, the entire contents of which are incorporated herein by reference.

### TECHNICAL FIELD

The present disclosure relates to the technical field of terminals, for example, relates to a method and an electronic device for processing terminal folder.

### BACKGROUND

As smart terminals are increasingly popular, application software which may run on the smart terminals is rapidly increased in terms of number and variety accordingly. To effectively manage the application software on the smart terminal, the application software may be classified, so that different types of application software are stored in corresponding types of folders. For example, application software related to navigation is stored in a navigation folder, application software related to video playing or video recording is stored in a video folder, application software related to music playing, music recording or music clipping is stored in a music folder, and tool application software, such as an alarm clock, a calendar or a calculator, is stored in a tool folder. Such a classifying manner facilitates a user to manage and find the corresponding application software.

However, in the smart terminals, a folder management manner is insufficiently smart, and has some problems in a folder management process, which affects the use experience of the user.

### SUMMARY

The present disclosure provides a method and an electronic device for processing terminal folder, which can facilitate a user to browse or open a sub-file in the folder.

The present disclosure provides a method for processing terminal folder, including: detecting a folder operation instruction triggered for a folder to be processed; dynamically scaling-displaying a folder icon of the folder to be processed according to the folder operation instruction; and dynamically adjusting a display of a sub-file icon in the folder icon according to a scale of the folder icon, wherein the sub-file is in the folder to be processed.

The present disclosure further provides a non-transitory computer readable storage medium, which stores computer executable instructions, wherein the computer executable instructions is used for executing the above method.

The present disclosure further provides an electronic device, including one or more processors, a memory and one or more programs, wherein the one or more programs are stored in the memory, and execute the above method when being executed by the one or more processors.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1A is a schematic diagram showing a folder display interface according to the related art;

FIG. 1B is a schematic diagram showing an application icon interface in a tool folder according to the related art;

FIG. 2A is a schematic flowchart showing a method for processing terminal folder according to Embodiment 1 of the present disclosure;

FIG. 2B is a schematic diagram showing a first scaling state display interface in a method for processing terminal folder according to Embodiment 1 of the present disclosure;

FIG. 2C is a schematic diagram showing a second scaling state display interface in a method for processing terminal folder according to Embodiment 1 of the present disclosure;

FIG. 2D is a schematic diagram showing a third scaling state display interface in a method for processing terminal folder according to Embodiment 1 of the present disclosure;

FIG. 2E is a schematic diagram showing a folder icon zooming-in display interface in a method for processing terminal folder according to Embodiment 1 of the present disclosure;

FIG. 2F is a schematic diagram showing a folder icon zooming-out display interface in a method for processing terminal folder according to Embodiment 1 of the present disclosure;

FIG. 2G is a schematic diagram showing a display interface where a subfolder icon is zoomed in following zooming-in of a folder icon in a method for processing terminal folder according to Embodiment 1 of the present disclosure;

FIG. 3 is a block diagram showing a structure of an electronic device for processing terminal folder according to Embodiment 2 of the present disclosure; and

FIG. 4 is a block diagram showing a hardware structure of an electronic device according to Embodiment 4 of the present disclosure.

### DETAILED DESCRIPTION

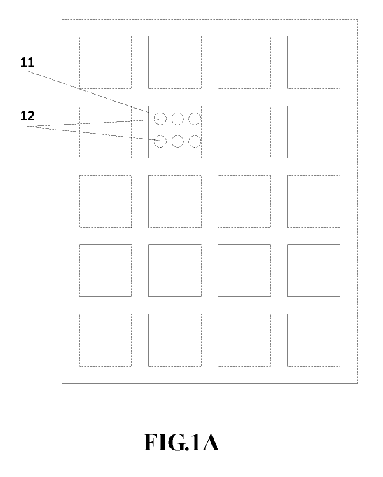

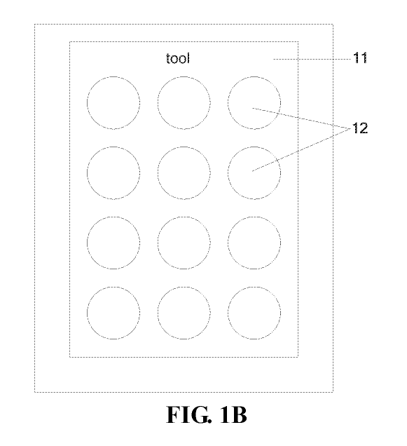

In the related art, in general, a size of the folder icon on a terminal display screen interface is identical to that of other application software icons on this interface. The size of the tool folder icon 11 on the terminal display screen interface as shown in FIG. 1A is identical to that of application software icons around this interface. In addition, since a size of a display area of the tool folder icon 11 is limited, the number of sub-file icons 12, which can be displayed in the tool folder icon 11, is limited. When the number of sub-files stored in the tool folder exceeds a display capability of the tool folder icon 11, partial sub-file icons 12 may be only displayed in the tool folder icon 11, and remaining sub-file icons 12, which may not be displayed in the current tool folder icon 11, are displayed in the opened tool folder with a need of clicking the tool folder icon 11 by a user. It will be described by using a case of storing 12 sub-files in the tool folder as an example, as shown in FIG. 1A, the current tool folder icon 11 only can display 6 sub-file icons 12. As shown in FIG. 1B, after the user clicks the tool folder icon 11, the tool folder is opened and displays 12 sub-file folders 12. When the user wants to use a sub-file in the tool folder, it may be required to determine the tool folder correspondingly storing the sub-file and the interface in which the tool folder is located firstly, then click the folder icon corresponding to the folder to open the folder, then position a to-be-opened sub-file icon, and finally click the sub-file icon to open the sub-file. The sub-file may be a file, a folder, application software and the like which are placed in the tool folder.

This process is completed by multiple manual operation steps of the user, and is relatively cumbersome in operation, resulting in time-consuming, labor-intensive operation of opening one piece of application software and low efficiency.

The present disclosure provides a method and an electronic device for processing terminal folder, which can facilitate the user to browse or open a sub-file in a folder.

The present disclosure will be described in detail below in conjunction with accompanying drawings and embodiments. It should be understood that the embodiments described herein are merely used for explaining the present disclosure, but not limiting the present disclosure. In addition, it is also noted that, for easy of description, relevant structures rather than all structures in an electronic device of the present disclosure are merely shown in the accompanying drawings.

### Embodiment 1

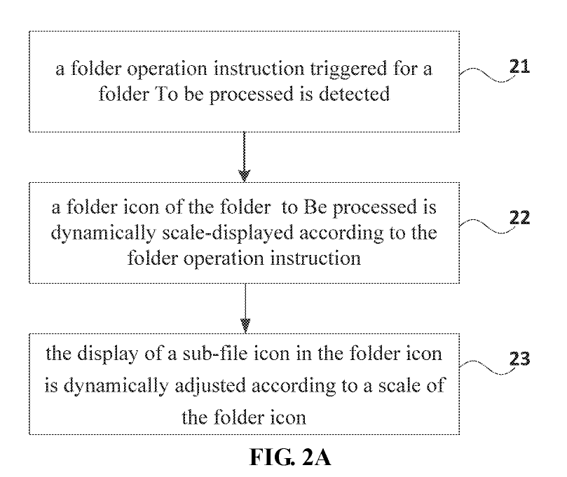

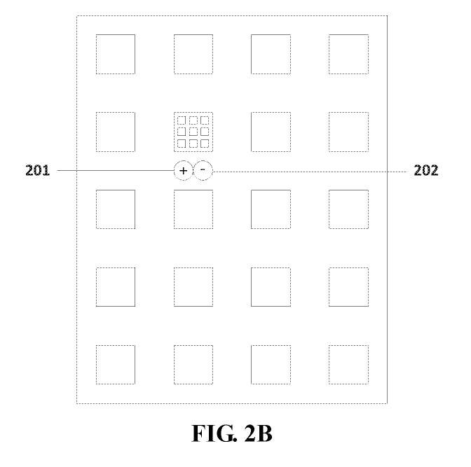

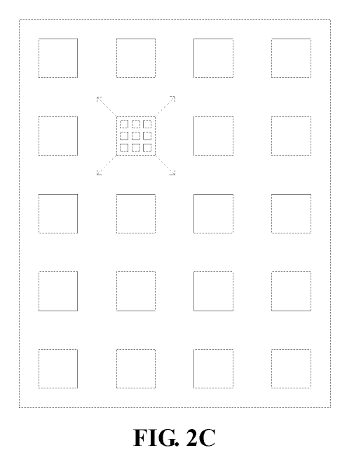

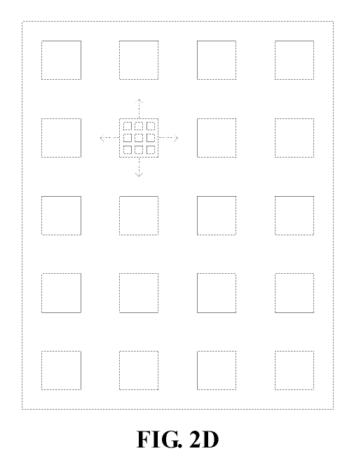

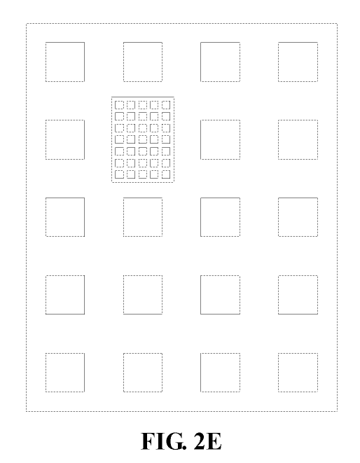

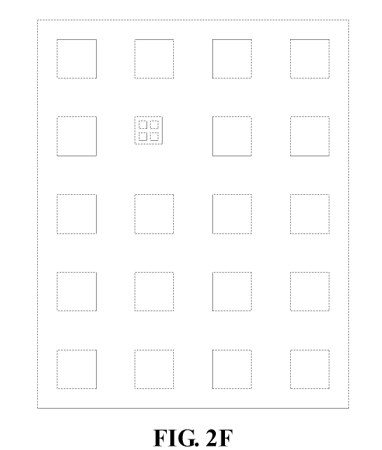

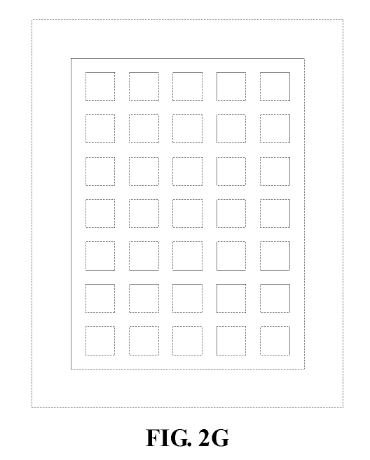

FIG. 2A is a schematic flowchart showing a method for processing terminal folder according to Embodiment 1 of the present disclosure. An executive body of this embodiment may be an electronic device for processing terminal folder, which is provided by an embodiment of the present disclosure or an electronic device (for example, a smart phone, a tablet personal computer and the like) integrating the electronic device for processing terminal folder, and the electronic device may be implemented by employing hardware and/or software. As shown in FIG. 2A, the method includes:

In step 21, a folder operation instruction triggered for a folder to be processed is detected.

The folder operation instruction may be an operation of long-press or double-click performed on the folder icon displayed on a display screen interface of the smart terminal, for example, the long-press may refer that the pressing time on the folder icon exceeds 5 s. The double-click may refer to continuous-click that a time interval between two times of clicking on the folder icon does not exceed 2 s, where the above pressing time and the time interval between two times of clicking may be flexibly set depending on needs of the user or set by default of smart terminal system.

Optionally, when the user wants to process a certain folder, the folder icon corresponding to the certain folder is selected, and long-pressed or double-clicked by using a finger, and then a terminal touch screen may detect an operation instruction of triggering the folder by the user.

In step 22, a folder icon of the folder to be processed is dynamically scale-displayed according to the folder operation instruction.

Optionally, after the folder operation instruction of the user is detected, the icon of the folder to be processed is in an adjustable state. One implementable scaling-displaying manner is as follows: a zoom-in button and/or a zoom-out button of the folder icon are/is provided for the user on the corresponding interface of the smart terminal, and may be displayed at a position around the folder icon, for example, as shown in FIG. 2B, the zoom-in button 201 and the zoom-out button 202 are both displayed below the folder icon, and in addition, may also be displayed above, at the left side or at the right side of the folder icon. The user may zoom in the folder icon by clicking the zoom-in button, and may zoom out the folder icon by clicking the zoom-out button.

A positional relationship between the zoom-in button and/or the zoom-out button and the folder icon is a relative positional relationship. When the user views in different angles, the positional relationship correspondingly changes without affecting implementation of the corresponding function of the zoom-in button and/or the zoom-out button.

Another implementable scaling-displaying manner is as follows: according to the folder operation instructions, a stretch guide line may be displayed on a terminal screen based on the folder icon; and according to a touch trajectory, based on the stretch guide line, of the user on the screen, the folder icon is scaled in a stretching manner in accordance with a direction of the touch trajectory. For example, as shown in FIG. 2C and FIG. 2D, when the fingers of the user move along any one or more stretch guide line directions (dotted arrows in the figures) as shown in FIG. 2C or FIG. 2D or the fingers of the user simultaneously move along four stretch guide line directions, the size of the folder icon may be zoomed in following movement directions of the stretch guide lines. The maximal size, that the folder icon is zoomed in, may be a size of the terminal screen. When the finger moves against any one stretch guide line direction as shown in FIG. 2C or FIG. 2D or the fingers simultaneously against four stretch guide line directions, the size of the folder icon may be zoomed out following the movement directions of the stretch guide lines. Optionally, the finger of the user moves along (against) any one stretch guide line direction, or multiple fingers of the user simultaneously move along (against) multiple stretch guide line directions, the shape of the folder icon may be maintained unchanged in a process of zooming in (or zooming out) the size of the folder icon following the movement directions of the stretch guide lines.

In step 23, the display of a sub-file icon in the folder icon is dynamically adjusted according to a scale of the folder icon.

The sub-file may be a file, a folder or application software which is placed in the folder, and the sub-file icon may be an icon corresponding to a sub-folder, and may also be an application icon corresponding to the application software, for example, the sub-file icon is a QQ icon, a WeChat icon or a QQ music icon.

Optionally, the display number of sub-file icons in the folder icon may be changed according to the scale of the folder icon and the sub-file in the folder to be processed. That is, when the size of the folder icon changes, the number of the sub-file icons currently displayed changes accordingly. For example, after the size of the icon of the folder to be processed is zoomed in, the number of the sub-file icons displayed may correspondingly increase; after the size of the icon of the folder to be processed is zoomed out, the number of the sub-file icons displayed may correspondingly reduce. As shown in FIG. 2E, it is a display result after the folder icon, as shown in FIG. 2C and FIG. 2D, is zoomed in; and as shown in FIG. 2F, it is a display result after the folder icon, as shown in FIG. 2C and FIG. 2D, is zoomed out.

It is noted that, when the size of the folder icon of the folder to be processed is zoomed in, other folder icons or application software icons positioned on the same interface with the folder icon may move to other interfaces of the smart terminal, for example, may move to an interface adjacent to the interface where the folder icon position; until the folder icon returns to a normal size (that is, returns to a state before adjustment), other folder icons or application software icons may move to corresponding positions of the interface where the folder icon position again; or other folder icons or application software icons may be covered by the folder icon zoomed-in; and until the folder icon returns to the normal size, other folder icons or application software icons may be displayed on the interface where the folder icon position again.

This embodiment dynamically scaling-displays the folder icon of the folder to be processed according to the folder operation instruction, and dynamically adjusts the displaying of the sub-file icon, in the folder icon, in the folder to be processed according to the scale of the folder icon, thereby positioning the corresponding sub-file icon is required according to the user's demand. Therefore, this embodiment can dynamically adjust the displaying of the sub-file icon, in the folder icon, in the folder to be processed, thereby making the user complete an opening operation, and increasing the efficiency.

Exemplarily, on the basis of the above embodiment, after dynamically adjusting displaying of the sub-file icon, in the folder icon, in the folder to be processed, the method further includes: receiving a sub-file opening instruction input under a display interface of the folder icon; when the size of the sub-file icon reaches a set threshold, opening the sub-file according to the sub-file opening instruction.

Optionally, after the sub-file icon required by the user is displayed on a corresponding terminal interface, the user may select a to-be-opened sub-file icon, and may automatically open the sub-file when the size of the sub-file icon reaches the set threshold. The set threshold may be customized according to a screen of a current terminal or an original size of the sub-file icon, for example, may be set as below: the size of the sub-file icon reaches or exceeds 80% of the original size. Alternatively, the user may start the sub-file by means of a manner of directly clicking the sub-file icon. A scaling operation of the folder icon may be described as below: the size of the folder icon may be fixed once scaling, so that the sub-file is directly browsed or opened in the folder icon subsequently, or the folder icon may return to the original size after the folder icon is scaled and an opening operation of the sub-file is completed.

Exemplarily, on the basis of the above embodiment, when detecting that all sub-file icons in the folder to be processed are displayed in the zoomed-in folder icon, if the folder icon is continuously zoomed in in a stretching manner, the sub-file icons are controlled to be proportionally zoomed in following the zooming-in of the folder icon.

As shown in FIG. 2G, it is a schematic diagram of the display result after the sub-file icon is proportionally zoomed in following the zooming-in of the folder icon.

Exemplarily, on the basis of the above embodiment, after the folder icon is scaled in a stretching manner in accordance with the direction of the touch trajectory to reach a target size, if you want to enable the folder to exit an adjustable state to revert to the normal working mode, it may be completed by the following two manners:

In the first manner, a stop operation instruction triggered in a predetermined area with respect to the folder to be processed is received; and according to the stop operation instruction, a stretch guide line of the folder to be processed is stopped from displaying, and a current scaling size of the folder icon is maintained.

The predetermined area may be a blank area outside the stretch guide line or the zoom-in button or the zoom-out button of the folder to be processed. For example, the user may enable the folder to be processed to exit the adjustable state to revert to the normal working mode by clicking the blank area; and at this moment, the size of the icon of the folder to be processed is the current scaling size.

In the second manner, when it is determined that a current scaling factor of the folder icon exceeds the preset ratio, the stretch guide line of the folder icon is stopped from displaying, and the current scaling size of the folder icon is maintained.

The preset ratio may be customized by the user.

Optionally, when the folder icon is zoomed in, the preset ratio is typically set to 80%. When detecting a current zooming-in ratio of the folder icon exceeds 80%, the stretch guide line of the folder icon is automatically hidden, and the folder to be processed exits the adjustable state.

Optionally, when the folder icon is of a square, a zooming-in ratio of the folder icon may refer to a zooming-in ratio of a side length of the folder icon. For example, the side length of the folder icon is 1 cm, and when detecting the zooming-in ratio of the folder icon exceeds 80% (that is, when detecting that the side length exceeds 1.8 cm after the folder icon is zoomed in), the stretch guide line of the folder icon is automatically hidden, and the folder to be processed exists the adjustable state.

When the folder icon is zoomed out, the preset ratio is typically set to 5%. When detecting a current zooming-out ratio of the folder icon exceeds 5%, the stretch guide line of the folder icon is automatically hidden, and the folder to be processed exits the adjustable state.

Optionally, when the folder icon is of a square, a zooming-out ratio of the folder icon may refer to a zooming-out ratio of a side length of the folder icon. For example, the side length of the folder icon is 1 cm, and when detecting the zooming-out ratio of the folder icon exceeds 5% (that is, when detecting that the side length is smaller than 0.05 cm after the folder icon is zoomed out), the stretch guide line of the folder icon is automatically hidden, and the folder to be processed exists the adjustable state.

Similarly, the above embodiments may dynamically scaling-display the folder icon of the folder to be processed according to the folder operation instruction, and dynamically adjust the display of the sub-file icon, in the folder icon, in the folder to be processed according to the scale of the folder icon, thereby making a user position to the corresponding sub-file icon as required. Therefore, the above embodiments can dynamically adjust the displaying of the sub-file icon, in the folder icon, in the folder to be processed, thereby making the user complete the opening operation, and increasing the efficiency.

### Embodiment 2

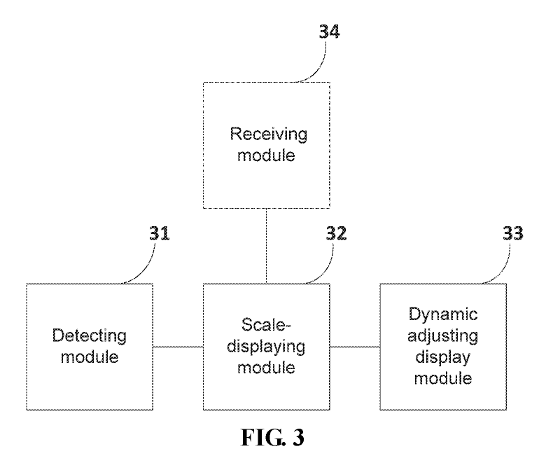

FIG. 3 is a block diagram of a structure of an electronic device for processing terminal folder according to Embodiment 2 of the present disclosure. The electronic device for processing terminal folder includes at least one processor and a storage device, wherein the storage device stores programs that are executable by the processor. The programs include a detecting module 31, a scaling-displaying module 32 and a dynamic adjusting module 33 as shown in FIG. 3.

The detecting module 33 is configured to detect a folder operation instruction triggered with respect to a the folder to be processed.

The scaling-displaying module 32 is configured to dynamically scaling-display a folder icon of the folder to be processed according to the folder operation instruction.

The dynamic adjusting module 33 is configured to dynamically adjust a display of a sub-file icon, in the folder icon, in the folder to be processed according to a scale of the folder icon.

The electronic device for processing terminal folder according to the embodiment of the present disclosure is used for performing the terminal folder processing method according to the above embodiments, and the technical principle and resulting technical effect are similar.

Exemplarily, on the basis of the above embodiment, the electronic device further includes a receiving module 34.

The receiving module 34 is configured to receive a sub-file opening instruction input under a display interface of the folder icon; and if a size of the sub-file icon reaches a set threshold, open the sub-file according to the sub-file opening instruction.

Exemplarily, on the basis of the above embodiment, the dynamic adjusting module 33 is configured to, according to the scale of the folder icon, change the display number of sub-file icons in the folder icon according to the sub-file in the folder to be processed.

Exemplarily, on the basis of the above embodiment, the dynamic adjusting module 33 is further configured to, after changing the display number of sub-file icons in the folder icon, if detecting that all sub-file icons in the folder to be processed are displayed in the zoomed-in folder icon, control the sub-file icons to be proportionally zoomed in following zooming-in of the folder icon.

Exemplarily, on the basis of the above embodiment, the scaling-displaying module 32 is specifically configured to, according to the folder operation instruction, display a stretch guide line on a terminal screen based on the folder icon; and according to a touch trajectory of a user on the screen based on the stretch guide line, perform stretch scaling on the folder icon in accordance with a direction of the touch trajectory.

Exemplarily, on the basis of the above embodiment, the receiving module 34 is further configured to, after the scaling-display module performs stretch scaling on the folder icon in accordance with the direction of the touch trajectory, receive the stop operation instruction triggered in a predetermined area with respect to the folder to be processed;

The scaling-displaying module 32 is further configured to stop displaying the stretch guide line of the folder to be processed according to the stop operation instruction, and maintain a current scaling size of the folder icon.

Exemplarily, on the basis of the above embodiment, the scaling-displaying module 32 is further configured to, after performing stretch scaling on the folder icon in accordance with the direction of the touch trajectory, when determining that a current scaling ratio of the folder icon exceeds a preset ratio, stop displaying the stretch guide line of the folder to be processed, and maintain a current scaling size of the folder icon.

Similarly, the electronic device for processing terminal folder according to the above embodiments is used for performing the terminal folder processing method according to the above embodiments, and the technical principle and resulting technical effect are similar.

### Embodiment 3

The present disclosure provides a non-transitory computer readable storage medium, which stores one or more modules, wherein the one or more modules enable the smart terminal to execute any one of the methods according to the above embodiments when being executed by the smart terminal of a terminal folder processing method.

### Embodiment 4

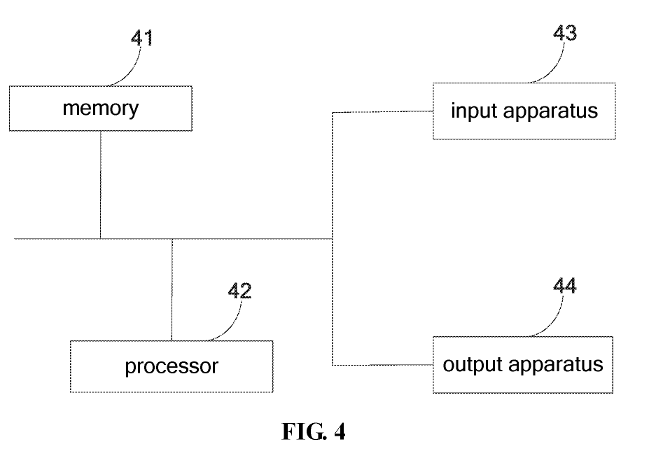

FIG. 4 is a block diagram of a hardware structure of a smart terminal according to Embodiment 4 of the present disclosure. As shown in FIG. 4, the smart terminal includes:

One or more processors 41 and a memory 42, wherein exemplified in FIG. 4 is one processor 41.

The smart terminal may further include an input apparatus 43 and an output apparatus 44.

The processor 41, the memory 42, the input apparatus 43 and the output apparatus 44 in the smart terminal may be connected by a bus or by any other means, and exemplified in FIG. 4 is a bus connection.

The memory 42, serving as a non-transitory computer readable storage medium, may be used to store a software program, a computer executable program and modules, such as program instructions/modules corresponding to the terminal folder processing method in the embodiments of the present disclosure (for example, the detecting module 31, the scaling-displaying module 32, the dynamic adjusting module 33 and the receiving module 34 as shown in FIG. 3). The processor 41 executes various functional applications of a server and data processing by running the software program, the instructions and the modules which are stored in the memory 42, that is, the terminal folder processing method according to the above method embodiments is realized.

The memory 42 may include a program storage area and a data storage area, wherein the program storage area may store an operating system, and at least one application required by a function; the data storage area may store data created according to the use of the smart terminal, and the like. In addition, the memory 42 may include a high-speed random access memory, and may further include a non-transitory memory, for example, at least one magnetic disk memory device, a flash memory device, or other non-transitory solid-state memory devices. In some embodiments, the memory 42 optionally includes memories remotely disposed relative to the processor 41, and these memories remotely disposed may be connected to an electronic device through a network. Instances of the above network include but not limited to Internet, Intranet, a local area network, a mobile communication network and a combination thereof.

The input apparatus 43 may be used to receive input digital or character information, and produce a key signal input related to user settings and function control of the electronic device. The output apparatus 44 may include display devices such as a display screen.

The one or more modules are stored in the memory 42, and execute any one of the methods in the above embodiments when being executed by the one or more processors 41.

It is noted that the foregoing is merely preferred embodiments of the present disclosure and the applied technical principle. It will be appreciated to those skilled in the art that the present disclosure is not limited to the embodiments described herein, but is capable of various modifications, rearrangements and substitutions as will become apparent to those skilled in the art without departing from a protective scope of the present disclosure.

The electronic equipment in embodiments of this application exists in various forms, including but not limited to:

(1) mobile telecommunication device. A device of this kind has a feature of mobile communicating function, and has a main object of providing voice and data communication. Devices of this kind include smart phone (such as iphone), multi-media cell phone, functional cell phone, low-end cell phone and the like;

(2) ultra mobile personal computer device. A device of this kind belongs to a category of personal computer, has functions of computing and processing, and generally has a feature of mobile internet access. Devices of this kind include PDA, MID, UMPC devices and the like, such as ipad;

(3) portable entertainment device. A device of this kind can display and play multi-media content. Devices of this kind include audio and video player (such as ipod), handheld game player, e-book, intelligent toy and portable vehicle navigation device;

(4) server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) other electronic devices having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement does not make essential of corresponding technical solutions depart from spirits and scope of technical solutions of various embodiments.

1. A method for processing terminal folder, comprising:
detecting a folder operation instruction triggered for a folder to be processed;
dynamically scaling-displaying a folder icon of the folder to be processed according to the folder operation instruction; and
dynamically adjusting a display of a sub-file icon in the folder icon according to a scale of the folder icon, wherein the sub-file is in the folder to be processed.

2. The method according to claim 1, further comprising:
receiving a sub-file opening instruction input in a display interface of the folder icon; and
if a size of the sub-file icon reaches a set threshold, opening the sub-file according to the sub-file opening instruction.

3. The method according to claim 1, wherein dynamically adjusting the display of the sub-file icon in the folder icon according to the scale of the folder icon comprises:
changing a display number of the sub-file icon in the folder icon according to the scale of the folder icon.

4. The method according to claim 3, wherein, after changing the display number of the sub-file icon in the folder icon, further comprising:
if detecting that all sub-file icons in the folder to be processed are displayed in a zoomed-in folder icon, controlling the sub-file icon to be proportionally zoomed in following zooming-in of the folder icon.

5. The method according to claim 1, wherein dynamically scaling-displaying the folder icon of the folder to be processed according to the folder operation instruction comprises:
displaying a stretch guide line on a terminal screen based on the folder icon according to the folder operation instruction; and
performing stretch scaling on the folder icon in accordance with a direction of a touch trajectory according to the touch trajectory of a user on the screen based on the stretch guide line.

6. The method according to claim 5, wherein, after performing stretch scaling on the folder icon in accordance with the direction of the touch trajectory, further comprising:
receiving a stop operation instruction triggered in a predetermined area for the folder to be processed; and
stopping displaying the stretch guide line of the folder to be processed, and maintaining a current scaling size of the folder icon according to the stop operation instruction.

7. The method according to claim 5, wherein, after performing stretch scaling on the folder icon in accordance with the direction of the touch trajectory, further comprising:
when determining that a current scaling ratio of the folder icon exceeds a preset ratio, stopping displaying the stretch guide line of the folder to be processed, and maintaining a current scaling size of the folder icon.

8. An electronic device for processing terminal folder, comprising:
at least one processor; and
a memory communicably connected with the at least one processor for storing instructions executable by the at least one processor, wherein execution of the instructions by the at least one processor causes the at least one processor to:
detect a folder operation instruction triggered with respect to a folder to be processed;
dynamically scaling-display a folder icon of the folder to be processed according to the folder operation instruction; and
dynamically adjust a display of a sub-file icon, in the folder icon, in the folder to be processed according to a scale of the folder icon.

9. The electronic device according to claim 8, wherein the execution of the instructions by the at least one processor further causes the at least one processor to:
receive a sub-file opening instruction input under a display interface of the folder icon; and
if a size of the sub-file icon reaches a set threshold, open the sub-file according to the sub-file opening instruction.

10. The electronic device according to claim 8, wherein to dynamically adjust the display of the sub-file icon, in the folder icon, in the folder to be processed according to the scale of the folder icon, the execution of the instructions by the at least one processor causes the at least one processor to:
change a display number of the sub-file icon in the folder icon according to the scale of the folder icon.

11. The electronic device according to claim 10, wherein the execution of the instructions by the at least one processor further causes the at least one processor to:
control the sub-file icon to be proportionally zoomed in following zooming-in of the folder icon, if detecting that all sub-file icons in the folder to be processed are displayed in the zoomed-in folder icon, and then changing the display number of the sub-file icon in the folder icon.

12. The electronic device according to claim 8, wherein to dynamically scaling-display the folder icon of the folder to be processed according to the folder operation instruction, the execution of the instructions by the at least one processor causes the at least one processor to:
display a stretch guide line on a terminal screen based on the folder icon according to the folder operation instruction; and
perform stretch scaling on the folder icon in accordance with a direction of a touch trajectory according to the touch trajectory of a user on the screen based on the stretch guide line.

13. The electronic device according to claim 12, wherein the execution of the instructions by the at least one processor further causes the at least one processor to:
after performing stretch scaling on the folder icon in accordance with the direction of the touch trajectory, receive a stop operation instruction triggered in a predetermined area with respect to the folder to be processed; and
stop displaying the stretch guide line of the folder to be processed according to the stop operation instruction, and maintain a current scaling size of the folder icon.

14. The electronic device according to claim 12, wherein the execution of the instructions by the at least one processor further causes the at least one processor to:
after performing stretch scaling on the folder icon in accordance with the direction of the touch trajectory, determine whether a current scaling ratio of the folder icon exceeds a preset ratio or not, if yes, stop displaying the stretch guide line of the folder to be processed, and maintain the current scaling size of the folder icon.

15. A non-transitory computer-readable storage medium, storing executable instructions that when executed by an electronic device, cause the electronic device to:
detect a folder operation instruction triggered with respect to a folder to be processed;
dynamically scaling-display a folder icon of the folder to be processed according to the folder operation instruction; and
dynamically adjust displaying of a sub-file icon, in the folder icon, in the folder to be processed according to a scale of the folder icon.

16. The non-transitory computer-readable storage medium according to claim 15, the executable instructions further cause the electronic device to:
receive a sub-file opening instruction input in a display interface of the folder icon; and
if a size of the sub-file icon reaches a set threshold, opening the sub-file according to the sub-file opening instruction.

17. The non-transitory computer-readable storage medium according to claim 15, wherein to dynamically adjust the display of the sub-file icon in the folder icon according to the scale of the folder icon-, the executable instructions further cause the electronic device to:
change a display number of the sub-file icon in the folder icon according to the scale of the folder icon.

18. The non-transitory computer-readable storage medium according to claim 15, wherein to dynamically scaling-display the folder icon of the folder to be processed according to the folder operation instruction, the execution of the instructions further cause the electronic device to:
display a stretch guide line on a terminal screen based on the folder icon according to the folder operation instruction; and
perform stretch scaling on the folder icon in accordance with a direction of a touch trajectory according to the touch trajectory of a user on the screen based on the stretch guide line.

19. The non-transitory computer-readable storage medium according to claim 18, the execution of the instructions further causes the electronic device to:
after performing stretch scaling on the folder icon in accordance with the direction of the touch trajectory, receive a stop operation instruction triggered in a predetermined area with respect to the folder to be processed; and
stop displaying the stretch guide line of the folder to be processed according to the stop operation instruction, and maintain a current scaling size of the folder icon.

20. The non-transitory computer-readable storage medium according to claim 18, wherein the execution of the instructions further causes the electronic device to:
after performing stretch scaling on the folder icon in accordance with the direction of the touch trajectory, determine whether a current scaling ratio of the folder icon exceeds a preset ratio or not, if yes, stop displaying the stretch guide line of the folder to be processed, and maintain the current scaling size of the folder icon.
